(19) United States
(12) Patent Application Publication
(10) Pub. No.: US 2017/0155836 A1
(43) Pub. Date: Jun. 1, 2017

(54) SYSTEM AND METHOD FOR SHOOT INTEGRATION

(71) Applicants: Inventec (Pudong) Technology Corporation, Shanghai (CN); INVENTEC CORPORATION, TAIPEI CITY (TW)

(72) Inventors: Kao-Sheng SU, TAIPEI CITY (TW); Lung-Hsun SONG, TAIPEI CITY (TW); Kuan-Hung CHEN, TAIPEI CITY (TW); Kang-Yu HSU, TAIPEI CITY (TW)

(21) Appl. No.: 15/091,536

(22) Filed: Apr. 5, 2016

(30) Foreign Application Priority Data
Nov. 30, 2015 (CN) 201510854558.0

(51) Int. Cl. H04N 5/232; H04N 5/247

(52) U.S. Cl. CPC H04N 5/23238; H04N 5/247; H04N 5/23203; H04N 5/23229

(57) ABSTRACT

The present invention discloses a system and method for shoot integration. The shoot integration method comprises the following steps: controlling a plurality of camera modules to shoot at the same time according to a shoot command; collecting a plurality of photos and/or videos shoot by the plurality of camera modules; recognizing each kind of specific information corresponded to the plurality of photos and/or videos to classify the plurality of photos and/or videos; and linking the same kind of photos and/or outputting the same kind of videos to be a panoramic video.

### RELATED APPLICATIONS

This application claims priority to Chinese Application Serial Number 201510854558.0, filed on Nov. 30, 2015, which is herein incorporated by reference.

### BACKGROUND

Field of Invention

The present invention relates to a system and method for shoot integration.

Description of Related Art

In the existing technology, for shooting a panoramic image or integrating files of a plurality of cameras, if there is only one camera, moving the camera manually is needed or by using a specific camera that can take a panoramic photo. In addition, for integrating files of a plurality of cameras, most operating system merely arranges files according to the file names or the shoot time, so that users cannot realize the relation between the files.

### SUMMARY

The invention provides a system and method for shoot integration. The shoot integration system makes an instruction through a single camera module or a central base to operate other camera modules to take photos or record videos synchronously. The shoot integration system retains the contents of the original photos or video files and adds additional specific information. For example, the specific information can be a combination code, a shoot time, and a position parameter corresponded to the same one shoot operation. Adding the specific information leads the images took at the same time have relevance, so that users can link the images or make a post-production for the video files efficiently.

An aspect of the disclosure is to provide a shoot integration system, which includes a plurality of camera modules and a central base. The central base connected to the plurality of camera modules, wherein the central base controls the plurality of camera modules to shoot at the same time according to a shoot command, the central base collects a plurality of photos and/or videos shoot by the plurality of camera modules, the central base recognizes each kind of specific information corresponded to the plurality of photos and/or videos to classify the plurality of photos and/or videos, and the central base links the same kind of photos and/or outputs the same kind of videos to be a panoramic video.

In one embodiment of the present invention, the specific information corresponded to the plurality of photos and/or videos can be a default file name, the default file name comprises a year information, a photo/video number and a combination code of the photos or videos, and the combination code is included in the shoot command, the combination code is a combination of English alphabets and digits.

In one embodiment of the present invention, the specific information corresponded to the plurality of photos and/or videos are that adding a label identification code in a file characteristic information of a exchangeable image file format (EXIF), the label identification code records a shoot time information and a serial number.

In one embodiment of the present invention, the specific information corresponded to the plurality of photos and/or videos are that adding a global positioning system (GPS) coordinate parameter in the file characteristic information of the EXIF.

In one embodiment of the present invention, wherein the central base recognizes the each kind of specific information corresponded to the plurality of photos to classify the plurality of photos, the specific information corresponded to the plurality of photos can be a default file name, the default file name comprises a year information, a photo number and a combination code of the photos, the combination code is included in the shoot command, the combination code is a combination of English alphabets and digits, the specific information corresponded to the plurality of photos further comprises adding a label identification code in a file characteristic information of a EXIF, the label identification code records a shoot time information and a serial number, the specific information corresponded to the plurality of photos further comprises adding a GPS coordinate parameter in the file characteristic information of the EXIF, the central base determines that if photos have the same year information, the same combination code, the same shoot time information, and the same GPS coordinate parameter, the photos are defined as the same kind of photos.

In one embodiment of the present invention, wherein the central base recognizes the each kind of specific information corresponded to the plurality of videos to classify the plurality of videos, the specific information corresponded to the plurality of videos can be a default file name, the default file name comprises a year information, a video number and a combination code of the videos, the combination code is included in the shoot command, the combination code is a combination of English alphabets and digits, the specific information corresponded to the plurality of videos further comprises adding a label identification code in a file characteristic information of a EXIF, the label identification code records a shoot time information and a serial number, the specific information corresponded to the plurality of videos further comprises adding a GPS coordinate parameter in the file characteristic information of the EXIF, the central base determines that if videos have the same year information, the same combination code, the same shoot time information, and the same GPS coordinate parameter, the videos are defined as the same kind of videos, and the shoot time information of each video includes a start time and an end time.

In one embodiment of the present invention, wherein steps of the central base links the same kind photos comprises that the central base recognizes an edge color and an edge object of the same kind photos, if two of the same kind of photos are determined as two adjacent photos, the central base calculates a height deviation and a angle deviation of the two adjacent photos, the central base adjusts a height and an angle of one of the two adjacent photos to align the other one, so as to link an edge overlapped area of the two adjacent photos.

In one embodiment of the present invention, wherein steps of the central base links the same kind photos further comprises that if an upper region or a lower region of one of the two adjacent photos is higher or lower than the other one after adjusting the height and the angle, the central base cuts the non-overlapped upper region and lower region.

In one embodiment of the present invention, wherein steps of the central base outputs the same kind of videos to be the panoramic video comprises that the central base analyzes the same kind of videos and captures recorded parts during the same period of each of the videos and combine the recorded parts to be the panoramic video.

An aspect of the disclosure is to provide a shoot integration method, the method comprises the following steps: controlling a plurality of camera modules to shoot at the same time according to a shoot command; collecting a plurality of photos and/or videos shoot by the plurality of camera modules; recognizing each kind of specific information corresponded to the plurality of photos and/or videos to classify the plurality of photos and/or videos; and linking the same kind of photos and/or outputting the same kind of videos to be a panoramic video.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A and FIG. 1B are configuration diagrams of the shoot integration system according to the present invention;

FIG. 2A is an operation diagram of the shoot integration system according to the first embodiment of the present invention;

FIG. 2B is an operation diagram of the shoot integration system according to the second embodiment of the present invention;

FIG. 2C is an operation diagram of the shoot integration system according to the third embodiment of the present invention;

FIG. 2D is an operation diagram of the shoot integration system according to the fourth embodiment of the present invention;

FIG. 3 is a flowchart of the shoot integration method according to the present invention;

FIG. 4A, 4B, 4C, 4D, and 4E are operation diagrams of image link according to the shoot integration system of the present invention; and

FIG. 5 is an operation diagram of outputting a panoramic video according to the shoot integration system of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Due to the complexity and difficulty of the existing method for shooting a panoramic image or integrating a plurality files, the shoot integration system of the present invention makes an instruction through a single camera module or a central base to operate other camera modules to take photos or record videos synchronously. Adding the specific information leads the images took at the same time have relevance, so that users can link the images or make a post-production for the video files efficiently.

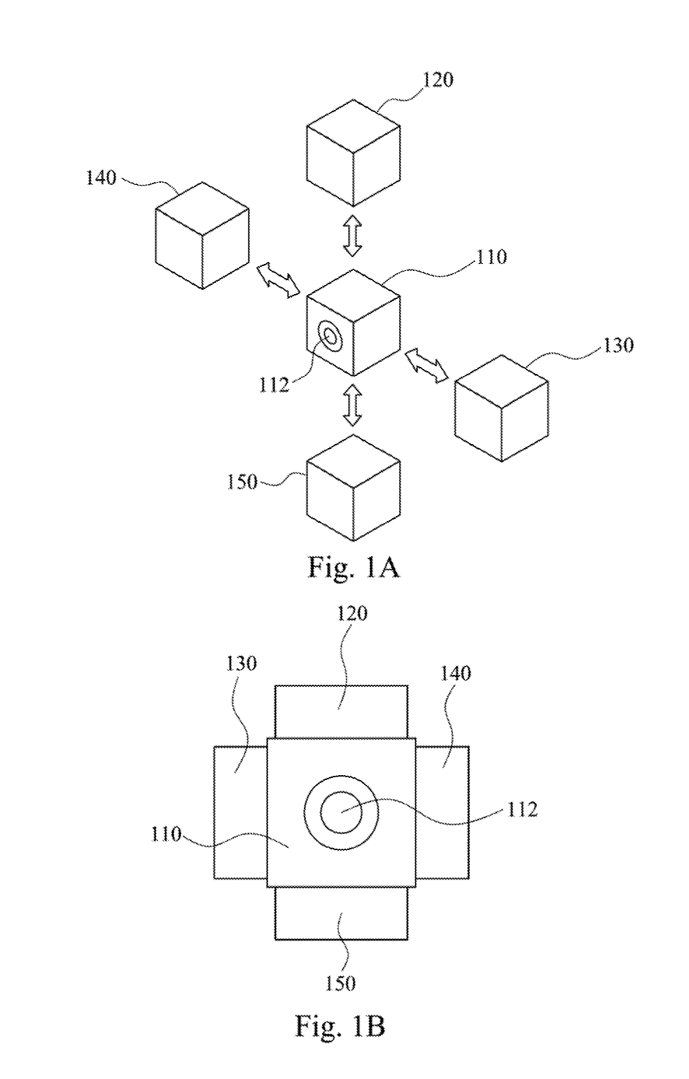

FIG. 1A and FIG. 1B are configuration diagrams of the shoot integration system according to the present invention. Referring to FIG. 1A, the shoot integration system includes a central base 110 and four camera modules 120, 130, 140, and 150. The structure of the central base 110 is a cube, four surfaces of the central base 110 has a magnet. The central base 110 is connected to the four camera modules 120, 130, 140 and 150 to by the magnetic force. In the embodiment disclosed in FIG. 1A, the central base 110 is connected to the four camera modules 120, 130, 140 and 150. In other embodiments of the present invention, the number of camera modules is based on the requirements of users. The central base 110 can connect to camera modules with other number by the magnetic force, in order to operate a panorama shooting.

Referring to FIG. 1B, FIG. 1B represents observing the shoot integration system of the present invention with a look down angle. Four surfaces f the central base 110 are connected to the camera modules 120, 130, 140, and 150. A shutter 112 is configured on another surface of the central base 110. The central base 110 has a signal processor. When the shutter 112 is pressed, the shoot command is generated. The signal processor of the central base 110 controls the four camera modules 120, 130, 140, and 150 to shoot. In addition, after the four camera modules 120, 130, 140 and 150 shoot, the photos or videos are transmitted to the central base 110 through the wireless network, for example, the bluetooth or WiFi.

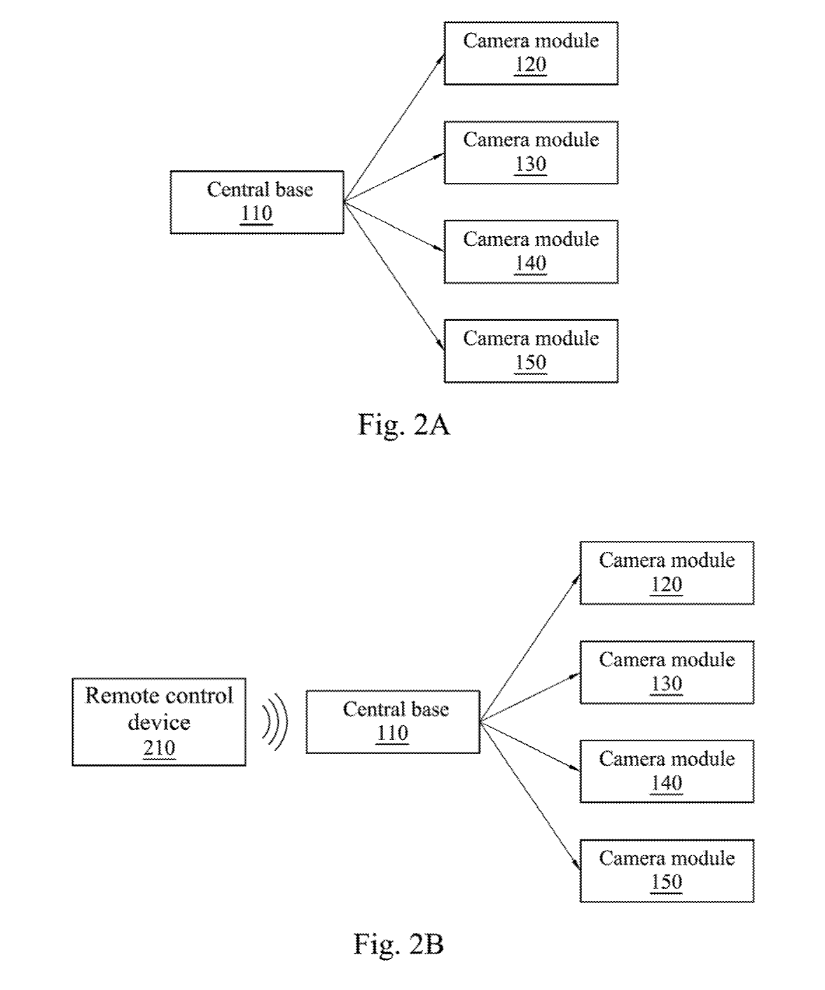

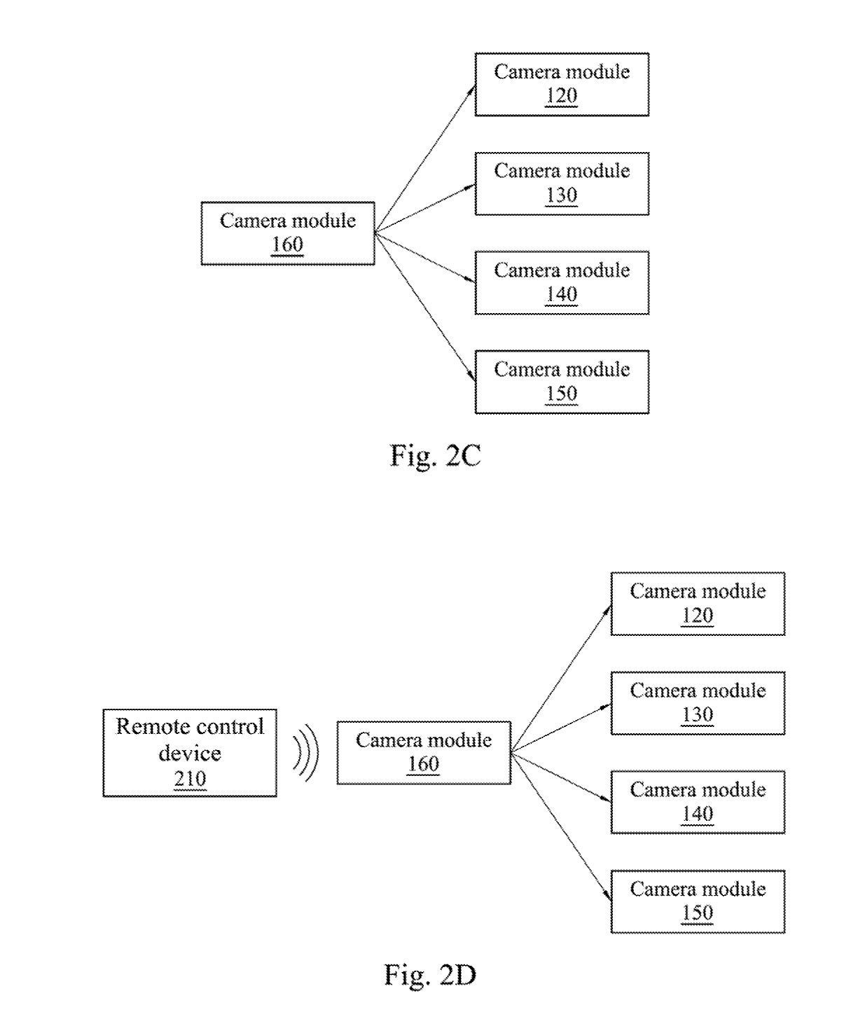

FIG. 2A is an operation diagram of the shoot integration system according to the first embodiment of the present invention. Referring to FIG. 2A, the central base 110 controls the plurality of camera modules 120, 130, 140, and 150 to shoot at the same time according to a shoot command. The scenario illustrated as FIG. 2A, the shoot command is generated by users pressing the shutter 112. Pressing the shutter 112 generates the shoot command, and the central base 110 controls the plurality of camera modules 120, 130, 140, and 150 to shoot at the same time according to the shoot command. FIG. 2B is an operation diagram of the shoot integration system according to the second embodiment of the present invention. Comparing to FIG. 2A, there are some differences between the two figures, In the second embodiment, a remote control device 210 generates the shoot command. The remote control device 210 can be a mobile device, such as a cell phone, a tablet, or a personal digital assistant (PDA). In the embodiment illustrated in FIG. 2B, the remote control device 210 transmits shoot commands to the central base 110 through the wireless network, such as bluetooth or WiFi. When the central base 110 receives the shoot commands transmitted by the remote control device 210, the central base 110 controls the plurality of camera modules 120, 130, 140, and 150 to shoot at the same time.

FIG. 2C is an operation diagram of the shoot integration system according to the third embodiment of the present invention. Comparing to FIG. 2A, the embodiment of FIG. 2C uses another camera module 160 to replace the central base 110 of the FIG. 2A. The camera module 160 can replace the central base 110 to control the a plurality of camera modules 120, 130, 140, and 150 to shoot at the same time according to the shoot command generated by the shutter 112. FIG. 2D is an operation diagram of the shoot integration system according to the fourth embodiment of the present invention. Comparing to FIG. 2B, the embodiment of FIG. 2D uses the camera module 160 to replace the central base 110 of FIG. 2B. The camera module 160 can replace the central base 110 to receive the shoot command transmitted by the remote control device 210, so as to control the a plurality of camera modules 120, 130, 140, and 150 to shoot at the same time.

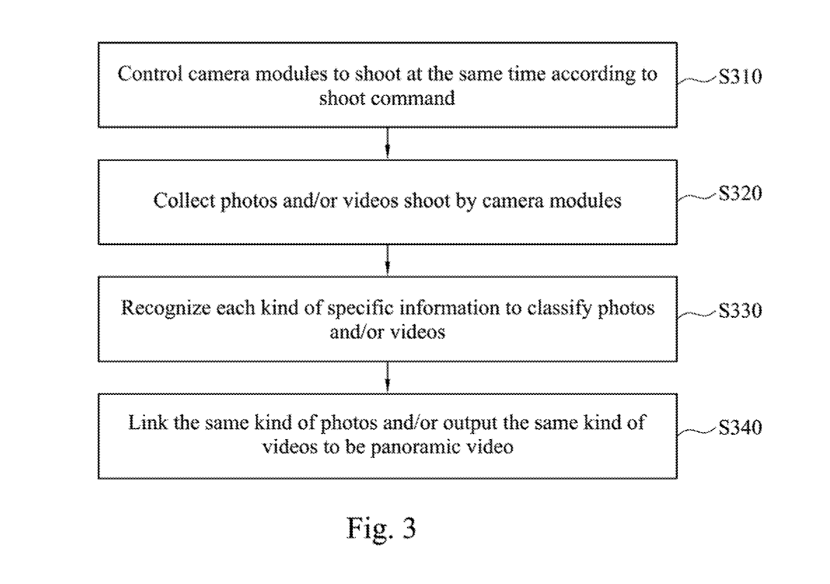

FIG. 3 is a flowchart of the shoot integration method according to the present invention. The following description uses the embodiment of FIG. 2A to explain the Step 310˜Step 340 of the flowchart of the FIG. 3. The central base 110 controls the plurality of camera modules 120, 130, 140, and 150 to shoot at the same time according to a shoot command (Step S310). Next, the central base 110 collects the plurality of photos and/or videos shoot by the plurality of camera modules 120, 130, 140, and 150 (Step S320). After the four camera modules 120, 130, 140, and 150 shoot the photos or videos, the central base 110 receives the plurality photos and/or videos shoot by the plurality of camera modules 120, 130, 140, and 150 through the wireless network, such as bluetooth and WiFi.

Next, the central base 110 recognizes each kind of the specific information corresponded to the plurality of photos and/or videos to classify the plurality of photos and/or videos (Step S330). In the embodiments of the present invention, there are pluralities of specific information, and one of them is a default file name. The default file name comprises year information, a photo/video number and a combination code of the photos or videos. The year information is defined as the year while shooting corresponded to western calendar. The photo/video number is defined as the shoot sequence of the photos/videos. The combination code is included in the shoot command, and the combination code is a combination of English alphabets and digits. The default file names of the photos and/or videos have the same combination code if the photos and/or videos are shoot at the same time. Namely, when the central base 110 receives a plurality of photos and/or videos, and the central base 110 determines that these photos and/or videos are shoot at the same time based on the same combination code.

The specific information corresponded to the plurality of photos and/or videos is that adding a label identification code in a file characteristic information of a exchangeable image file format (EXIF), and the label identification code records a shoot time information and a serial number. The serial number indicates the shoot sequence. In addition, for video format, the shoot time information includes a start time and an end time. The photos and/or videos have the same shoot time information if the photos and/or videos are shoot at the same time. Namely, when the central base 110 receives a plurality of photos and/or videos, and the central base 110 determines that these photos and/or videos are shoot at the same time based on the same shoot time information.

The specific information corresponded to the plurality of photos and/or videos are that adding a global positioning system (GPS) coordinate parameter in the file characteristic information of the EXIF. The photos and/or videos have the same GPS coordinate parameter if the photos and/or videos are shoot at the same time. Namely, when the central base 110 receives a plurality of photos and/or videos, and the central base 110 determines that these photos and/or videos are shoot at the same time based on the same GPS coordinate parameter.

Based on the above descriptions, if the photos have the same year information and the same combination code of the default file name, the same shoot time information, and the same GPS coordinate parameter, the central base 110 determines that the photos are the same kind. In addition, for the video format, if the videos have the same year information and the same combination code of the default file name, the same shoot time information, and the same GPS coordinate parameter, the central base 110 determines that the videos are the same kind. The shoot time information of each video includes a start time and an end time.

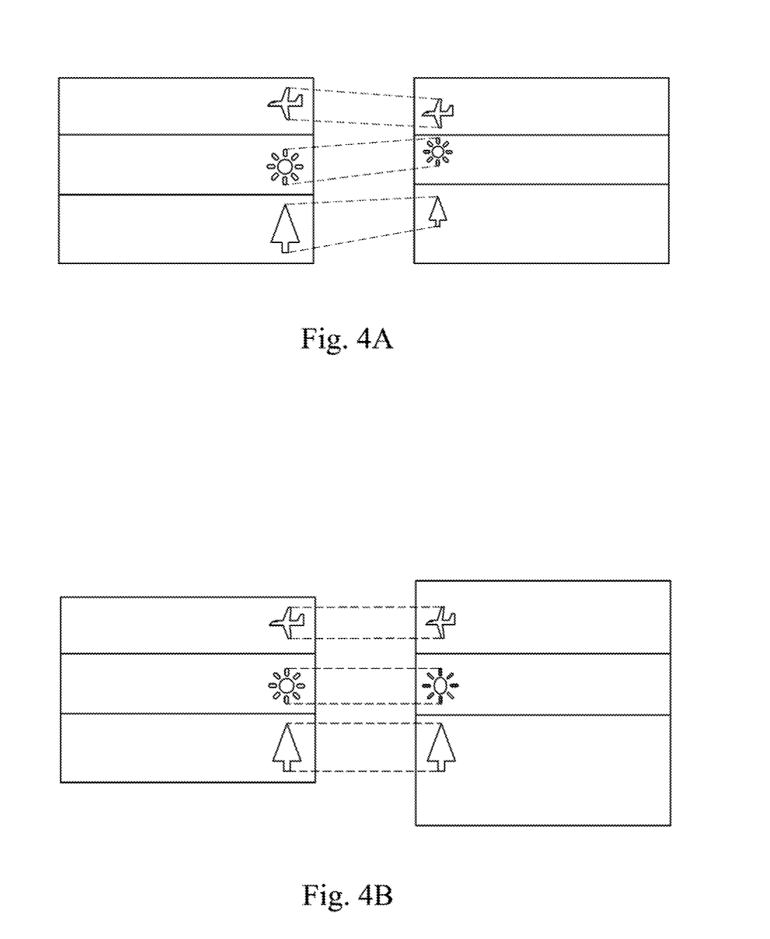

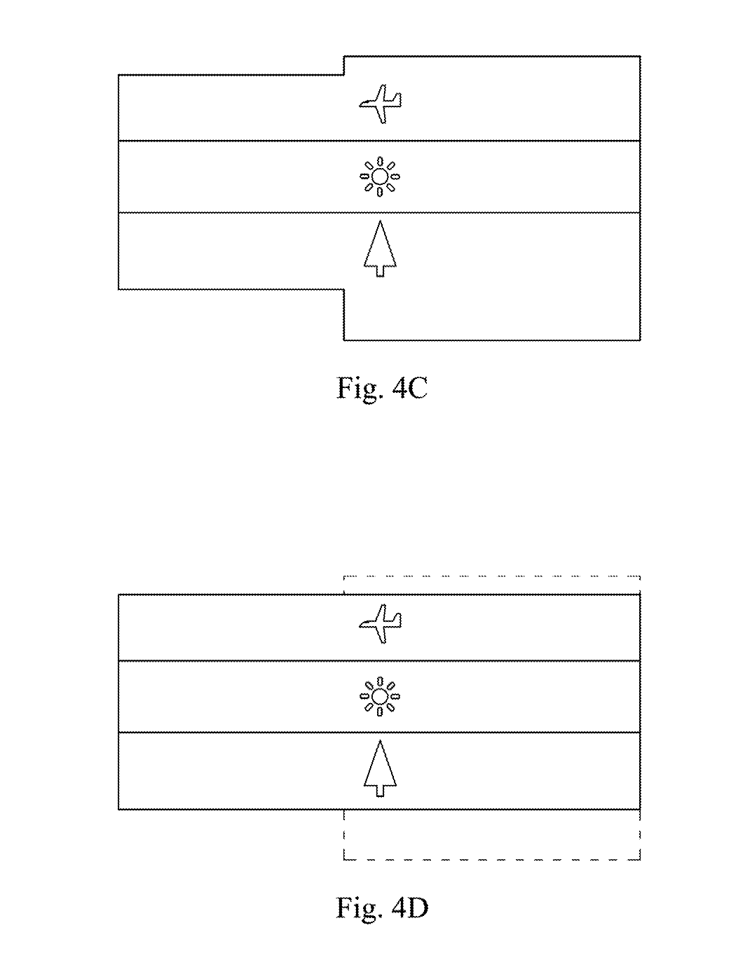

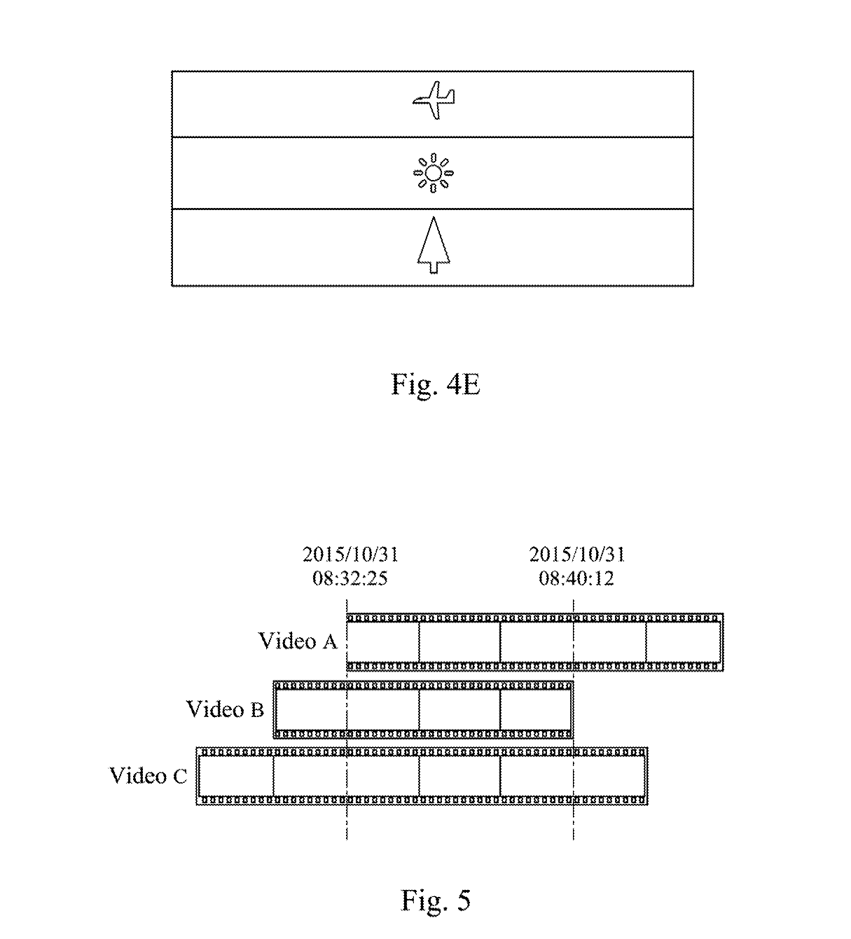

Next, the central base 110 links the same kind of photos and/or outputs the same kind of videos to be a panoramic video (Step S340). For the photo format, the process of linking the same kind of photos further comprises the following steps. FIGS. 4A, 4B, 4C, 4D, and 4E are operation diagrams of image link according to the shoot integration system of the present invention. Referring to FIG. 4A, 4B, 4C, 4D, and 4E, the central base 110 recognizes an edge color and an edge object of the same kind photos (as illustrated in FIG. 4A). If two of the same kind of photos are determined as two adjacent photos, the central base 110 calculates a height deviation and a angle deviation of the two adjacent photos, and the central base 110 adjusts a height and an angle of one of the two adjacent photos to align the other one (as illustrated in FIG. 4B). The central base 110 links an edge overlapped area of the two adjacent photos (as illustrated in FIG. 4C). If an upper region or a lower region of one of the two adjacent photos is higher or lower than the other one after adjusting the height and the angle, the central base 110 cuts the non-overlapped upper region and lower region (as illustrated in FIG. 4D). Finally, the link and adjustment of the images are complete (as illustrated in FIG. 4E).

FIG. 5 is an operation diagram of outputting a panoramic video according to the shoot integration system of the present invention. For the video format, the central base 110 outputs the same kind of videos to be the panoramic video comprises that the central base 110 analyzes the same kind of videos and captures recorded parts during the same period of each of the videos and combine the recorded parts to be the panoramic video. As illustrated in FIG. 5, each of the same kind of videos A, B, and C has the recorded part during the period of 8:32:25 to 8:40:12, 2015/10/31 respectively, and the central base 110 captures the recorded part of the videos A, B, and C respectively and operate a post-production for them in order to output the panoramic video.

When the post-production is operated, the shoot integration system of the present invention collects videos that have relevance of time and space, and recognizes three specific information (the combination code of the default file name, the shoot time information, and the GPS coordinate parameter). After collecting, the sequences of videos are arranged according to the relevance. Marking recorded parts of the videos is the simplest way to let users to operate the post-production for the videos within a short time. In addition, the shoot integration system of the present invention also captures the recorded parts of each of the videos to output the panoramic video.

For the structure of the shoot integration system of the present invention, the central base connected to the plurality of camera modules through the magnetic force, so as to reduce the complexity of the mechanical structure. The present does not need too much line configurations cause of sending images by the wireless network. Accordingly, the production cost is reduced.

The invention provides a system and method for shoot integration. The shoot integration system makes an instruction through a single camera module or a central base to operate other camera modules to take photos or record videos synchronously. The shoot integration system retains the contents of the original photos or video files and adds additional specific information. For example, the specific information can be a combination code, a shoot time, and a position parameter corresponded to the same one shoot operation. Adding the specific information leads the images took at the same time have relevance, so that users can link the images or make a post-production for the video files efficiently.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A shoot integration system, comprising:
a plurality of camera modules; and
a central base connected to the plurality of camera modules, wherein the central base controls the plurality of camera modules to shoot at the same time according to a shoot command, the central base collects a plurality of photos and/or videos shoot by the plurality of camera modules, the central base recognizes each kind of specific information corresponded to the plurality of photos and/or videos to classify the plurality of photos and/or videos, and the central base links the same kind of photos and/or outputs the same kind of videos to be a panoramic video.

2. The shoot integration system of claim 1, wherein the specific information corresponded to the plurality of photos and/or videos can be a default file name, the default file name comprises a year information, a photo/video number and a combination code of the photos or videos, the combination code is included in the shoot command, the combination code is a combination of English alphabets and digits.

3. The shoot integration system of claim 1, wherein the specific information corresponded to the plurality of photos and/or videos are that adding a label identification code in a file characteristic information of a exchangeable image file format (EXIF), the label identification code records a shoot time information and a serial number.

4. The shoot integration system of claim 1, wherein the specific information corresponded to the plurality of photos and/or videos are that adding a global positioning system (GPS) coordinate parameter in the file characteristic information of the EXIF.

5. The shoot integration system of claim 1, wherein the central base recognizes the each kind of specific information corresponded to the plurality of photos to classify the plurality of photos, the specific information corresponded to the plurality of photos can be a default file name, the default file name comprises a year information, a photo number and a combination code of the photos, the combination code is included in the shoot command, the combination code is a combination of English alphabets and digits, the specific information corresponded to the plurality of photos further comprises adding a label identification code in a file characteristic information of a EXIF, the label identification code records a shoot time information and a serial number, the specific information corresponded to the plurality of photos further comprises adding a GPS coordinate parameter in the file characteristic information of the EXIF, the central base determines that if photos have the same year information, the same combination code, the same shoot time information, and the same GPS coordinate parameter, the photos are defined as the same kind of photos.

6. The shoot integration system of claim 1, wherein the central base recognizes the each kind of specific information corresponded to the plurality of videos to classify the plurality of videos, the specific information corresponded to the plurality of videos can be a default file name, the default file name comprises a year information, a video number and a combination code of the videos, the combination code is included in the shoot command, the combination code is a combination of English alphabets and digits, the specific information corresponded to the plurality of videos further comprises adding a label identification code in a file characteristic information of a EXIF, the label identification code records a shoot time information and a serial number, the specific information corresponded to the plurality of videos further comprises adding a GPS coordinate parameter in the file characteristic information of the EXIF, the central base determines that if videos have the same year information, the same combination code, the same shoot time information, and the same GPS coordinate parameter, the videos are defined as the same kind of videos, and the shoot time information of each video includes a start time and an end time.

7. The shoot integration system of claim 1, wherein steps of the central base links the same kind photos comprises that the central base recognizes an edge color and an edge object of the same kind photos, if two of the same kind of photos are determined as two adjacent photos, the central base calculates a height deviation and a angle deviation of the two adjacent photos, the central base adjusts a height and an angle of one of the two adjacent photos to align the other one, so as to link an edge overlapped area of the two adjacent photos.

8. The shoot integration system of claim 7, wherein steps of the central base links the same kind photos further comprises that if an upper region or a lower region of one of the two adjacent photos is higher or lower than the other one after adjusting the height and the angle, the central base cuts the non-overlapped upper region and lower region.

9. The shoot integration system of claim 1, wherein steps of the central base outputs the same kind of videos to be the panoramic video comprises that the central base analyzes the same kind of videos and captures recorded parts during the same period of each of the videos and combine the recorded parts to be the panoramic video.

10. A shoot integration method, comprising:
controlling a plurality of camera modules to shoot at the same time according to a shoot command;
collecting a plurality of photos and/or videos shoot by the plurality of camera modules;
recognizing each kind of specific information corresponded to the plurality of photos and/or videos to classify the plurality of photos and/or videos; and
linking the same kind of photos and/or outputting the same kind of videos to be a panoramic video.
